(19) United States
(12) Patent Application Publication
(10) Pub. No.: US 2008/0139111 A1
(43) Pub. Date: Jun. 12, 2008

(54) Time-sharing mobile information devices over the internet

(76) Inventors: Mudassir Ilyas Sheikha, Palo Alto, CA (US); David John Marsyla, Belmont, CA (US); Faraz Ali Syed, Dublin, CA (US)

Correspondence Address: MORRISON & FOERSTER, LLP, 555 WEST FIFTH STREET, SUITE 3500, LOS ANGELES, CA, 90013-1024, US

(21) Appl. No.: 11/635,916

(22) Filed: Dec. 7, 2006

(51) Int. Cl. H04M 11/00

(52) U.S. Cl. 455/3.04; 455/409

(57) ABSTRACT

The time-sharing of mobile devices over the Internet between remote users that need access to them is disclosed. Mobile devices are distributed across the globe in target geographies and networks, and users are provided with over-the-Internet access to these devices. The mobile devices are grouped in a mobile device pool. Devices in the pool can be in different physical locations, but they all report their locations and status to a central server (“AccessServer”) using standard internet protocols. This central server gives a single unified view of the mobile device pool to the user. Users are able to get this unified view and access the mobile devices using a software application (“DeviceConductor”) that runs on their local computer. A user can check-out a device and operate it remotely, having the ability to control all inputs of the device and view all outputs from the device.

### FIELD OF THE INVENTION

This invention relates to the time-sharing of mobile information processing devices over the internet among users that need access to the devices for the purpose of developing and testing applications on those devices, for presenting content and applications designed for those devices, for providing customer support to users using those devices, and for any other activities that require access to the physical devices.

### BACKGROUND OF THE INVENTION

A large number of mobile information processing devices (“mobile devices”) are produced and sold each year. Even a larger number of applications and services (“mobile applications”) are produced to either run on these mobile devices or be accessed from them. The act of developing, marketing, selling and supporting these mobile applications requires significant access to the actual physical mobile devices.

Currently, the most common way to get access to mobile devices is to buy and take physical possession of them. Due to the large number of mobile devices that come out each year and the variations between copies of the same model sold by different network operators, it is impractical for all but the largest companies to buy all models and variations. Even if a company can buy all devices, it takes additional investment in the form of personnel to manage and share the devices, and in allocating a safe physical space to store and protect the devices. Moreover, if a company has users in multiple locations that need access to devices, multiple copies of devices need to be purchased and managed for every location.

Another way to get access to mobile devices has been through developer labs. These are physical facilities that contain a large number of mobile devices, mostly belonging to the particular device manufacturer or network operator hosting the lab. Users can use devices within the lab by paying a certain fee. However, the labs are few and far apart, and each contains a small subset of the available devices. They mostly exist in big cities, and users have to travel to the location of the labs to use them. Moreover, their utility is somewhat limited. Use-cases that require access to devices outside the lab (e.g., presenting an application on the device to a potential partner) or on a more regular basis (e.g., providing customer support) are simply not possible to achieve with this approach.

In addition to getting access to devices, a second challenge is getting access to the target wireless networks, such as GSM, GPRS, CDMA, WCDMA, EDGE, 3G, 802.xx, etc (“wireless networks”). For certain activities, especially those around networked applications and services, it is very important to be in the target network with the target devices. This often requires users to travel thousand of miles to the target geographies. It makes such activities expensive, time-consuming and cumbersome.

Therefore, there is a need to make mobile devices available to users that need access to them in a manner that does not require them to spend thousands of dollars buying devices, that absolves them from the need of traveling to target networks with these devices, and that provides immediate and constant on-demand access.

### SUMMARY OF THE INVENTION

The present invention provides a means to time-share mobile devices over the internet among users that need access to them. It distributes mobile devices across the globe in target geographies and networks, and gives users over-the-internet access to these devices.

The devices to be time-shared are grouped in the mobile device pool. The mobile device pool comprises mobile devices distributed across locations and wireless networks. Devices in the pool can be in different physical locations, but they all report their locations and status to a central server (“AccessServer”) over standard internet protocols. This central server gives a single unified view of the mobile device pool to the user.

Users are able to get this unified view of devices in the mobile device pool from within a software application (“DeviceConductor”) that runs on their local computer. DeviceConductor connects to the mobile device pool over standard internet protocols and gives users access to devices in the pool. A user can check-out a device (and become the “owner”) and operate it remotely. The user is able to control all inputs of the device and view all outputs from the device. The inputs may include key presses, hardware control (battery, power charger, flip, etc.), microphone (audio in) and others. The outputs may include LCDs (video), speakers (audio out) and others.

A single device can only be used by one user at a time. While the device is checked-out and in use by a certain user, other users are not able to use the device. Instead, they are given the option to wait on the device in a first-in-first-out (FIFO) queue. Once the device is checked-in by the last user, the device is granted to the next available user after being ‘cleaned’. Cleaning is performed by an automated script that runs on the device and is responsible for wiping out any applications, customizations, etc. that may be performed on the device by the last user.

To avoid having to wait on a device, the user has the option of making a prior reservation for the device. A reservation guarantees the user access to the reserved device during the reserved time-slots.

### BRIEF DESCRIPTION OF THE DRAWINGS

FIG. 1 is a block diagram of an exemplary system environment according to some embodiments of this invention.

FIG. 2 is a block diagram of an exemplary Remote User and a Local Computer accessing a Mobile Device Pool according to some embodiments of this invention.

FIG. 3 illustrates an exemplary Device Image as it appears on a user interface as provided by DeviceConductor according to some embodiments of this invention.

FIG. 4 is a block diagram illustrating the exemplary sharing of Mobile Devices according to some embodiments of this invention.

FIG. 5 is a block diagram of an exemplary Mobile Device Pool according to some embodiments of this invention.

FIG. 6 is a block diagram of an exemplary communication of device status according to some embodiments of this invention.

FIG. 7 is a flow diagram of exemplary Mobile Device states according to some embodiments of this invention.

FIG. 8 is a block diagram of exemplary Revoke Device functionality according to some embodiments of this invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

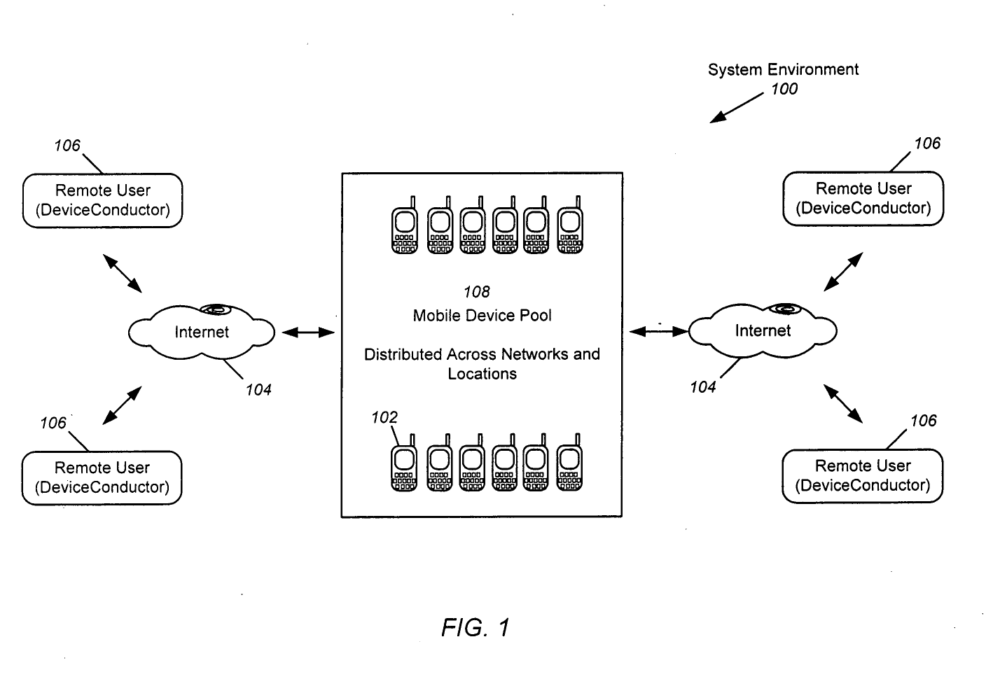

FIG. 1 is a block diagram of an exemplary system environment 100 according to some embodiments of this invention. Embodiments of the present invention are directed to the time-sharing of mobile devices 102 over the Internet 104 between remote users 106 that need access to them. Mobile devices 102 are distributed across the globe in target geographies and networks, and users 106 are provided with over-the-Internet access to these devices. The mobile devices 102 to be time-shared are grouped in a mobile device pool 108 comprised of mobile devices distributed across locations and wireless networks. Devices 102 in the pool 108 can be in different physical locations, but they all report their locations and status to a central server (“AccessServer”) using standard internet protocols. This central server gives a single unified view of the mobile device pool 108 to the user 106. Users 106 are able to get this unified view and access the mobile devices 102 using a software application (“DeviceConductor”) that runs on their local computer. A user 106 can check-out a device 102 and operate it remotely, having the ability to control all inputs of the device and view all outputs from the device. The inputs may include key presses, hardware control (battery, power charger, flip, etc.), microphone (audio in) and others. The outputs may include LCDs (video), speakers (audio out) and others.

### Remote User

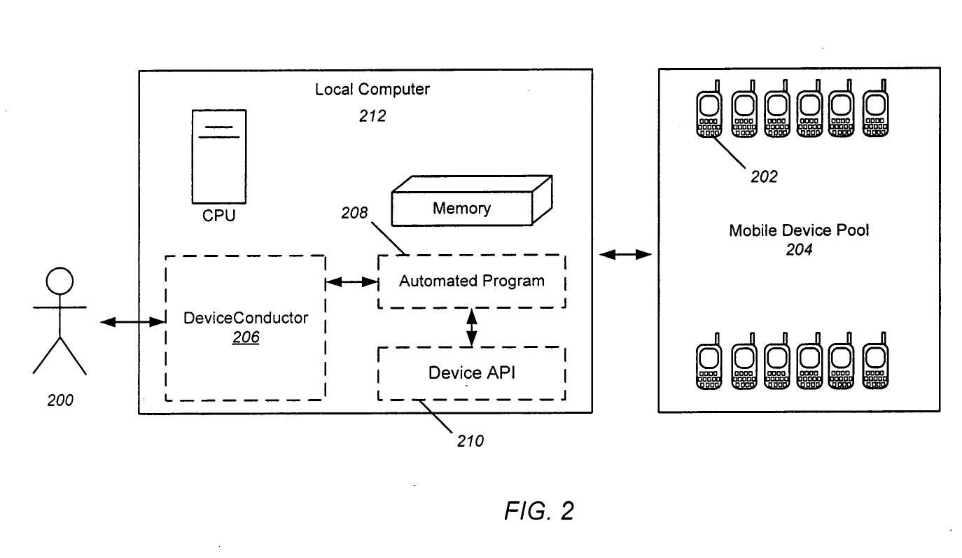

FIG. 2 is a block diagram of an exemplary Remote User and a Local Computer accessing a Mobile Device Pool according to some embodiments of this invention. A remote user 200 is either a person or an automated application that controls one of more mobile devices 202 in the mobile device pool 204. In the case where the remote user 200 is a person, the person interacts with the DeviceConductor software application 206 to interact with one or more mobile devices in the mobile device pool.

If the remote user 200 is replaced with an automated program 208, it runs in unattended mode and performs any or all of the same interactions with DeviceConductor 206. It does that by either using the DeviceConductor software application 206 or through an application programming interface (“Device API”) 210.

### Device Conductor

DeviceConductor 206 is a software application that is operated by a remote user 200 or automate program 208 to get access to the mobile devices 202 in the mobile device pool 204 and operate them. It runs on a local computer 212 and connects to the mobile device pool 204 over standard internet protocols.

When a user launches and logs into DeviceConductor 206, he/she sees a list of devices 202 from the mobile device pool 204. The devices 202 may be grouped into packages, organized by manufacturer, wireless network, or any other criteria as determined by the system administrator. The list of devices 202 seen by a particular user is configurable by the administrator from within the mobile device pool administration interface (“MobileHarmony”).

From the perspective of DeviceConductor 206, the devices in this list can be in one of the following four states:

(1) Available: This means that the device is available and ready for use. A user can check-out and operate a device in this state. The user has the option to view upcoming reservations (see the section on reservations below) on the device before checking-out the device.

(2) Checked-out: This means that the device is currently in use by another user. A user can wait in the queue for this device to become available. The user will have the option to view the current state of the queue and get an approximate wait time. The state of the queue comprises the following details: (a) Current owner of the device; (b) Time when the device was checked-out by this owner; (c) Users in the queue; (d) Times when those users joined the queue; and (e) Average session times of the users in the queue (based on recent history). Based on group memberships of the user, the user will or will not see the exact identities of the owner and the users in the queue. The system is sensitive to privacy concerns of users. Finally, the approximate wait time is computed based on the average session times of the owner and users in the queue.

(3) Being cleaned: This means that the device is being cleaned after being checked-in by a user. A user can wait in the queue for this device to become available. Similar to the checked-out state above, a user will be able to view the current state of the queue and get an approximate wait time. Since a device is being shared with multiple users from potentially different companies, it is important that the state of the device is reset after every use. In the absence of such a cleaning mechanism, users will be able to learn about the activities of users before them, and given that most users are working on proprietary applications, it is highly undesirable.

(4) Offline: This means that the device is offline and not available for use. The offline status means that the device is currently not connected in the mobile device pool. Reasons for this absence may range all the way from the device needing repair to the device being needed for another purpose elsewhere. The reason can be defined by the administrator from within MobileHarmony and be will be shown along with the device to users who have access to that device.

To avoid having to wait on a device 202, a user 200 can make an advance reservation for the device. The reservation can be made from within DeviceConductor 206 or from the end-user screens in MobileHarmony. There can be only one reservation for a device in a certain time-slot. A reservation guarantees access to the reserved device in the reserved time-slots. If another user is using the device at the reserved time, the device is taken from the existing user (with advance warning) and is put in the mobile device pool to wait for the user with the reservation.

A user can checkout and operate multiple devices in the pool simultaneously. The number of simultaneous device check-outs is configurable by the administrator from within MobileHarmony. The checked-out devices can be in any number of locations or networks.

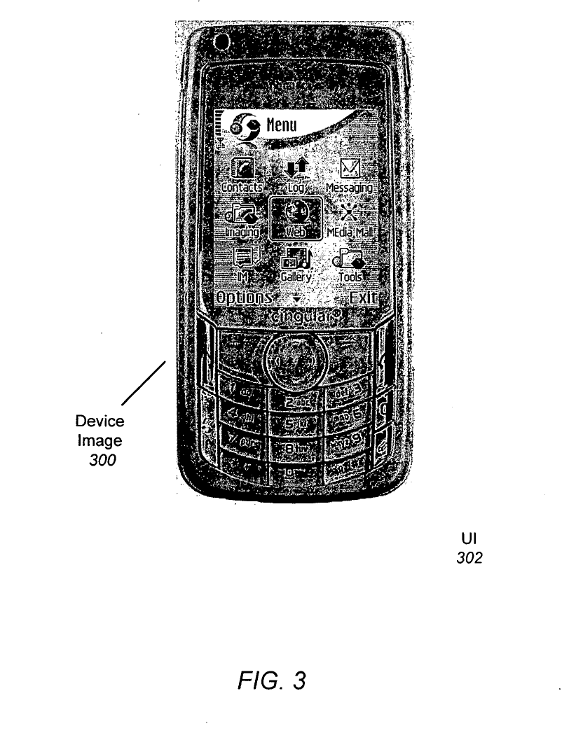

FIG. 3 illustrates an exemplary Device Image 300 as it appears on a user interface 302 as provided by DeviceConductor according to some embodiments of this invention. When a user checks out a device, an image 300 of that device becomes visible in DeviceConductor. This image 300 displays the exact form-factor of the device along with all the keys on the device and the LCD screen. For devices that have multiple form-factors (e.g., flip mobile devices), DeviceConductor gives users the option to remotely change the state of the device (and hence the form-factor). When the device state changes, the image 300 in the DeviceConductor also changes to reflect the new form-factor. The new image may reveal additional keys and LCD for the user to interact with.

To press a key on the remote mobile device, the user may point the computer mouse to the key in the device image and click it. This will trigger a network message from DeviceConductor to the remote device and the relevant key will be pressed on the actual device in the remote location. The longer the mouse is pressed, the longer the key will be pressed on the remote mobile device.

The video from the remote mobile device can be streamed back to DeviceConductor and played in the LCD section of the device image. The video may be streamed constantly, so as soon as the video changes on the actual remote device, the change is reflected in the device image in DeviceConductor (with minimal delay due to internet). If there are multiple LCD screens on the device, multiple streams are sent to DeviceConductor from the device. Depending on the current state of the device, the relevant one is displayed.

The audio from the remote mobile device is also being streamed back to DeviceConductor and can be heard on the speakers connected to the local computer. The audio may include voice, ringers, music, or anything else that may be playing on the actual remote device. If multiple devices are being used simultaneously, the audio from the currently selected device is played.

If the remote mobile device has a microphone and can be spoken into, DeviceConductor allows the user to speak into the device by speaking into the microphone connected to the local computer. DeviceConductor streams the audio from the local computer to the remote mobile device. If multiple devices are being used simultaneously, the audio is streamed into the currently selected device.

Lastly, the user is able to control the physical hardware of the remote mobile device. The following are some examples of hardware control: (1) Battery connect/disconnect: This allows the user to connect or disconnect the battery to the device; (2) Power Charger connect/disconnect: This allows the user to connect or disconnect the power charger; (3) Data Cable connect/disconnect: If there is a data cable connected to the device, this allows the user to connect or disconnect that data cable; and (4) Open/Close Flip: If it is a flip phone, this allows the user to open or close the flip. This option typically changes the device image that is displayed in DeviceConductor to reflect the new form-factor of the device.

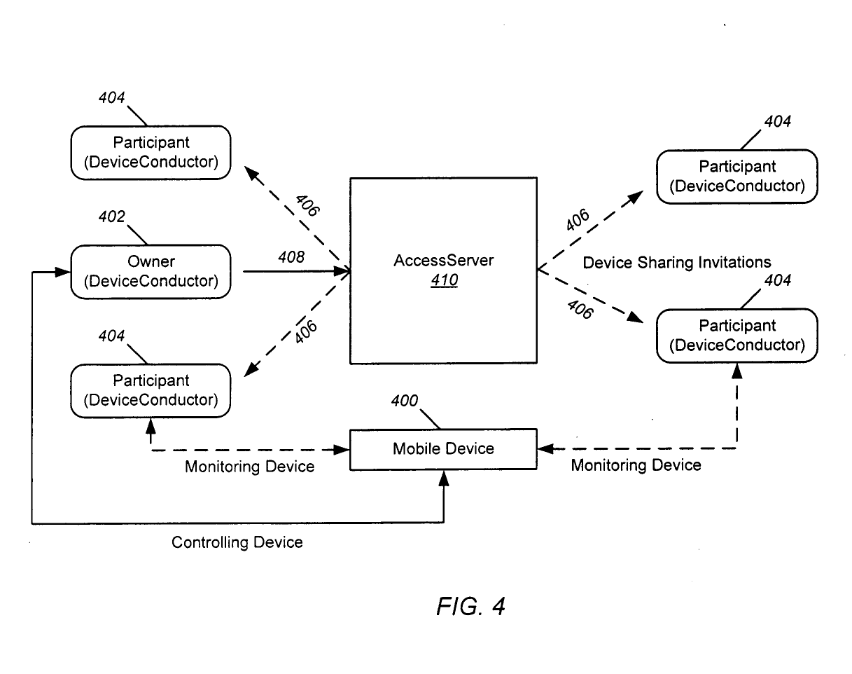

FIG. 4 is a block diagram illustrating the exemplary sharing of a Mobile Device 400 according to some embodiments of this invention. Once the user has access to the device, the device can be shared by the owner (“primary owner”) 402 with one or more other users (“participants”) 404. Device sharing works similar to common desktop sharing programs like NetMeeting and Webex, but instead of the desktop, the mobile device 400 is shared. The owner 402 is able to provide the inputs to the device (press keys, speak into the microphone, change the hardware controls), and the shared users are able to see the interactions of the owner and view the outputs from the device (video, audio) in their own DeviceConductor sessions.

The owner can initiate the sharing session by sending an electronic invitation 406 (email, instant message, or direct message within DeviceConductor) to other users. If the invited users accept the invitation, the device image shows up in their local DeviceConductor sessions and they are able to see the interactions of the owner with the device, and the video/audio outputs from the device.

While the invitation 408 propagates through the AccessServer 410, once the invitations are accepted, the participant DeviceConductor instances 404 contact the device directly and tap into the audio and video streams from the device. The owner of the device continues to control the device and get the audio/video streams from it. The participants 404, although have access to the audio/video streams from the device, are not able to control the device until or unless they are explicitly granted control by the primary owner of device.

To transfer the control of the device, the owner DeviceConductor instance 402 sends a message to the device indicating the transfer of control along with the ID of the DeviceConductor instance to transfer the control to. The device transfers over the control to the “secondary owner” and sends a message back to the recipient DeviceConductor instance informing it of the new controls. The secondary owner is now able to operate the device and perform inputs on it.

However, the primary ownership of the shared device still rests with the primary owner. The secondary owner is not able to invite or remove users from the shared session, or transfer the control to other users. The primary owner, on the other hand, has the option to take away control from the secondary owner and either keep the control to itself or transfer it over to another participant.

Once the device has been shared, the owner of the device can perform the following functions (in addition to providing inputs to the device): (1) Pause the sharing session. This pauses the streaming of information to participants; (2) Resume the sharing session. This resumes the streaming of information; (3) Invite additional users to the sharing session; (4) Remove existing users from the sharing session; (5) Transfer device control to one or more users sharing the device; (6) Revoke device control from one or more users controlling the shared device; (7) Interact with the shared users over chat and voice based built-in instant messaging; and (8) Terminate the sharing session. This stops the sharing.

The invited users can perform the following functions during the sharing session: (1) Leave the sharing session; (2) Interact with the owner and other participants over a text/audio-based chat session; and (3) If they have been given control of the device, provide inputs to the device.

DeviceConductor provides a controller to control the audio/video stream from the remote mobile device. It provides this functionality by maintaining a local cache of the audio and video that it streams back to the user. The controller essentially provides a means to view different sections of this cache. The size of the cache is configurable and depends on the memory storage available on the local computer. This controller makes the following functionality available to the device owner from within DeviceConductor: (1) Ability to pause the live audio/video from the remote mobile device; and (2) Ability to go back and look at recent audio/video from the remote mobile device. This functionality is especially useful for developers and testers of applications and services who are often interested in looking back at the historical data to trouble-shoot and diagnose issues.

While the local cache is useful for inspecting recent output from the device, it is impractical to store large amounts of data in the local computer's memory. Moreover, memory is short-lived and does not persist data over application restart. Therefore, it is useful to allow the user to export the results either to a central database from which the results can be shared with other users, or to a portable format on the local file-system which the owner can communicate to other users over standard communication means like email and content management systems (for e.g., bug tracking systems).

As such, DeviceConductor provides the following three means of exporting the results: (1) Store a video frame or audio sample on the file-system in a standard format (WAV, PNG, JPEG, etc.). The audio or video output can be shared with other users via email or content management systems like bug tracking systems; (2) Generate and store a movie of the video/audio output on the file-system in a standard format (AVI, MPEG, etc.). The movie can be shared with other users via email or content management systems like bug tracking systems. Additionally, the movie can also be used as training material for internal and external users of the particular application, service or device; and (3) Upload a set of video frames and audio samples to the database. These results can be viewed and shared by the user from within MobileHarmony.

DeviceConductor also allows the user to script a set of key presses on the device and schedule the script at a time in the future. The scripting interfaces allow the user to press keys on the device, inspect the LCD of the device for text or bitmap patterns, and contains constructs like loops, branches, variables, etc. that are available in most programming languages.

A user is able to use the scripting environment to automate a certain function. Examples of such functions could be playing a music file, sending SMS, accessing a web URL, loading an application on the device, etc. A script can have multiple success and failure conditions, and these conditions can be defined by the user.

Once a script has been written, it can be run either manually from within DeviceConductor or scheduled to run at a given time in the future. An automation server picks up any scheduled runs and runs them at the scheduled time. The results of the run, which include the result of the script execution and the screenshots of the device LCD at the time of execution, are stored in the database and made available to the user from within the end-user screens in MobileHarmony.

### Mobile Device Pool

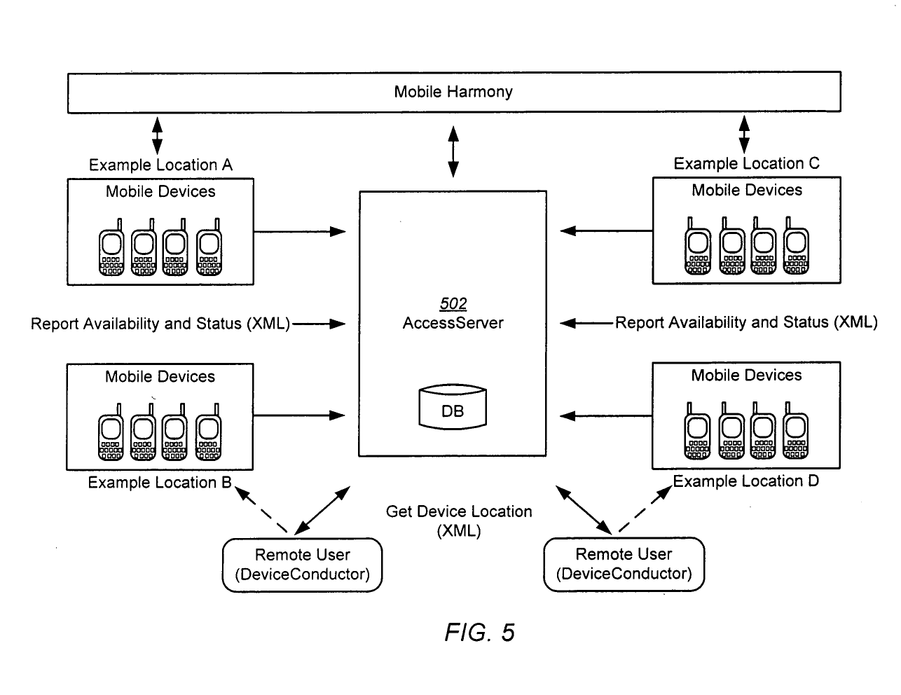

FIG. 5 is a block diagram of an exemplary Mobile Device Pool 500 according to some embodiments of this invention. The Mobile Device Pool 500 is the collection of time-shared mobile devices. The devices in this pool can be on different geographies and different networks. All devices communicate their locations and availability to the central AccessServer 502. When a certain DeviceConductor instance needs access to a device, it contacts the AccessServer 502 for the location of that device and then contacts the device directly at that location.

The AccessServer 502 is the central component of the mobile device pool. It facilitates the connection between the devices in the pool and the users of those devices. The AccessServer maintains a list of all devices available in the pool, their locations and their most recent status. It gets this information in the form of network messages from the individual devices. When a device comes online in the mobile device pool, it sends a message to the AccessServer with its identity and location. The AccessServer accumulates this information across all devices and makes this information available to DeviceConductor instances when they connect to it.

As the status of devices in the pool change, the devices send messages to the AccessServer with their most recent status. The following events change the state of the device and trigger a message to the AccessServer: (1) Device comes online; (2) Device goes offline; (3) Device gets checked-out; (4) Device gets checked-in; (5) Device starts running cleanup script; and (6) Device finishes running cleanup script.

When a user launches DeviceConductor to access devices, the DeviceConductor application logs into the AccessServer and fetches the most recent location and status of all devices of interest. Based on the location and status provided, the DeviceConductor establishes a direct connection to the remote device and either checks it out or starts waiting in the queue for that device.

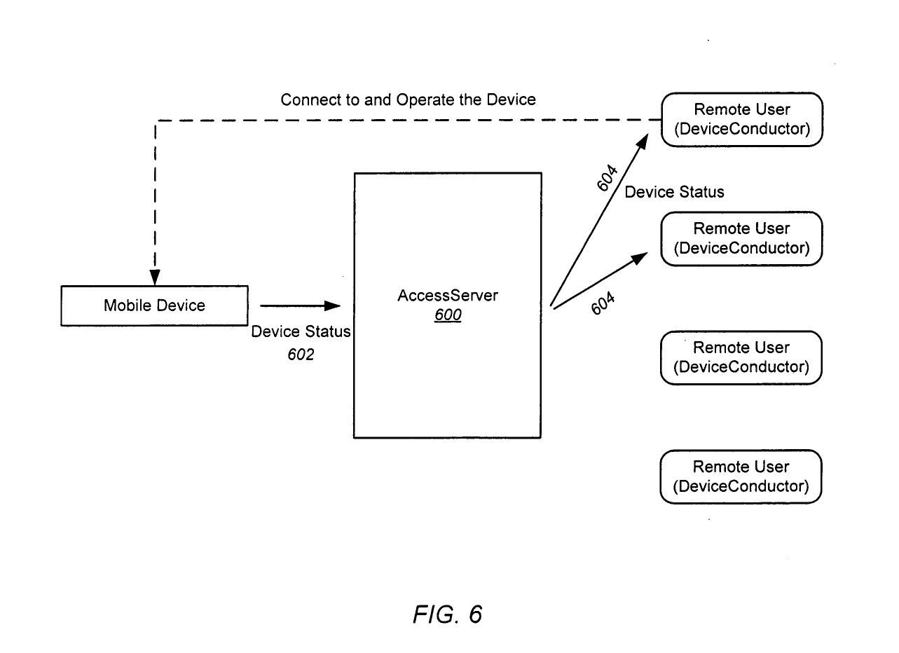

FIG. 6 is a block diagram of an exemplary communication of device status according to some embodiments of this invention. Along with the information on all devices, the AccessServer 600 also maintains a list of all DeviceConductor instances connected to it and their respective devices of interest. Therefore, when the status of a device changes and the AccessServer gets a state change message (see 602), it is able to quickly compile a list of DeviceConductor instances interested in that particular device and forward the status to those DeviceConductor instances (see 604).

The above mechanism ensures that all DeviceConductor instances connected to the AccessServer 600 have the most recent location and status of all devices of interest. A DeviceConductor instance is able to use this information to make a direct connection to the device and either use it or wait in the queue for it.

The devices in the mobile device pool may report their status to the AccessServer in two ways. In the first way, they may report their status directly to the AccessServer. This may be done through a wireless network that the devices are connected to. In the second approach, a bunch of devices may be physically connected to a server (“DeviceServer”) through USB, Bluetooth or other local connection mechanism. The DeviceServer would detect the devices connected to it and forward the location and status of these devices over standard internet protocols to the AccessServer. In the latter case, the communication between DeviceConductor and the devices would also happen through the DeviceServer.

The AccessServer may use a database (relational, object or other) to query and store information about users and devices. The user information is used to determine who can get access to the mobile device pool and what devices they have access to. The device information is used to provide information about the devices to users.

Additionally, the database is also used to store device usage information. The mobile device pool tracks the usage of devices across users and devices. The information is gathered by having mobile devices report usage at the end of every user session. The report is sent in the form of a network message from the device to the AccessServer. AccessServer stores this information in the database and the information is presented to the user and the system administrator within MobileHarmony. The information may be used to analyze usage statistics or to bill users for the time spent on devices.

Mobile devices can be distributed across locations and wireless networks. In a remote location, mobile devices can be organized in one of two ways. In the first case, mobile devices are connected physically to local server (“DeviceServer”) over USB, Bluetooth, Firewire or other local connection mechanism. This DeviceServer is responsible for all communication between the devices and either the AccessServer or DeviceConductor instances that connect to the device. The DeviceServer acts as the gatekeeper for the device and maintains the queue and other relevant constructs for time-sharing of devices connected to it. In a single location, there may be multiple DeviceServers connected to one or more devices, reporting the status of their devices to the AccessServer and accepting incoming connections for those devices from DeviceConductor instances.

In the second case, the mobile devices are connected directly to the AccessServer and DeviceConductor instances over a wireless network like GSM, GPRS, CDMA, WiFi, WiMax, etc. The devices transmit their own statuses to the AccessServer and accept incoming connections from DeviceConductor instances.

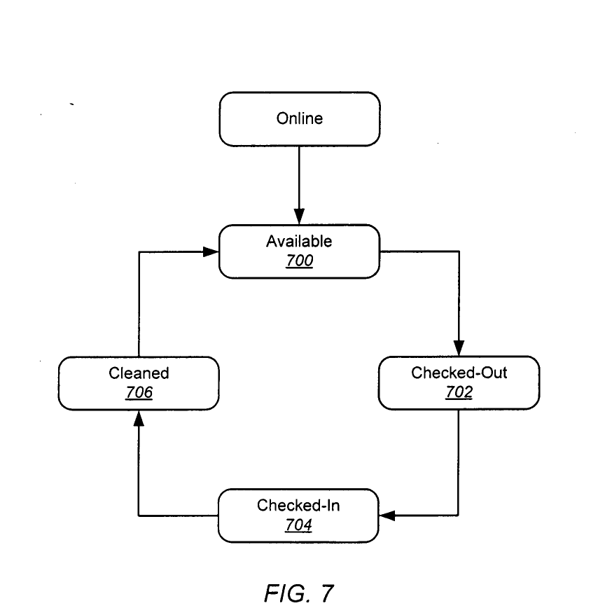

FIG. 7 is a flow diagram of exemplary Mobile Device states according to some embodiments of this invention. Regardless of the above mechanism, a mobile device in the time-shared pool goes from being available (ready to use) 700, to being checked-out (in use) 702, to getting checked-in 704, to being cleaned 706 and becoming available again.

A device is cleaned by an automated script that gets invoked after the device is checked-in by a user. The automated script is typically unique to a device type and can be customized per deployment. The script is meant to clean the device before next use, but it can also be used to pre-configure the device before next use. The following are some typical functions that the cleanup script performs: (1) Remove user applications; (2) Delete all messages (SMS, MMS, E-mail, etc.); (3) Delete user bookmarks; (4) Delete user ring-tones and other media files; (5) Reset cache and delete web/URL history; (6) Reset wallpaper to factory default; and (7) Delete user-added profiles.

For some devices, the above functions can be performed in a single sweep by entering a factory reset code on the device. This code resets the device to the factory default state. For devices where such a code is available, the automated script simply types the code on the device and the cleanup is performed automatically. In other cases, the automated script has to manually go to the relevant menus on the device and perform the cleanup.

MobileHarmony is a web-based reporting, collaboration and administration platform. MobileHarmony provides users the ability to perform the following functions: (1) Edit their user profile; (2) View and track their usage on devices; (3) Add/Remove devices from their DeviceConductor view; (4) View and share captured results; (5) Create/Edit/Cancel reservation on devices.

Administrators have the ability to perform the above functions across all users. In addition, they have the following functions available to them: (1) Create users, user-groups and assign users to user-groups; (2) Group devices into device-groups; (3) Assign devices or device-groups to users and user-groups; (4) Allocate allowances to users and user-groups to restrict time allowed on devices; (5) View the location and status of all available devices; and (6) Revoke a device from an active user and assign it to a user in the queue.

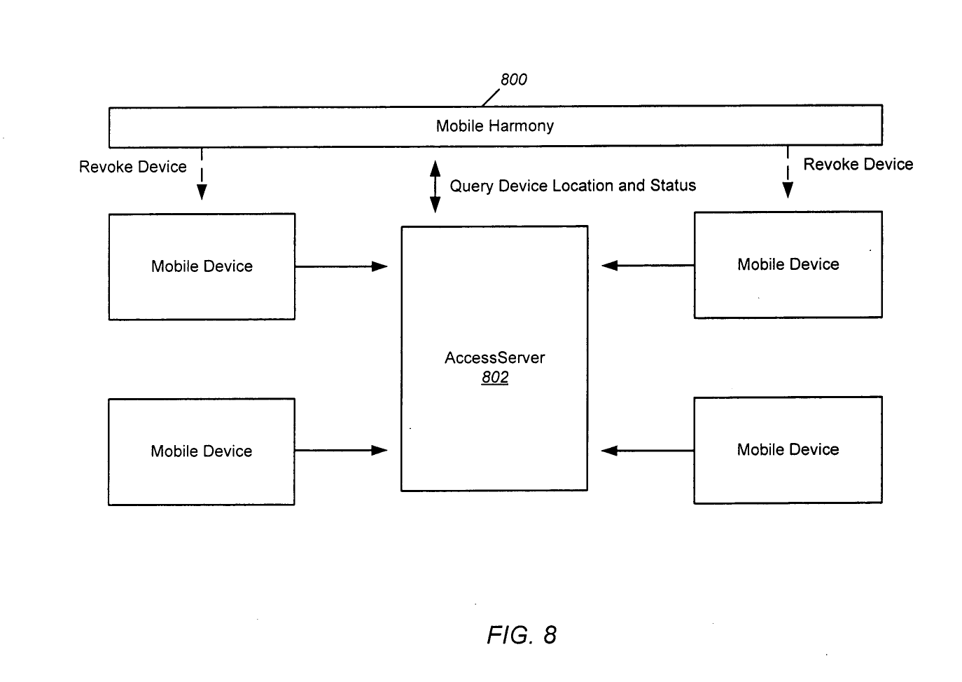

FIG. 8 is a block diagram of exemplary Revoke Device functionality according to some embodiments of this invention. MobileHarmony 800 gets the location and status of all devices from the AccessServer 802. To revoke the device from a certain user, MobileHarmony 800 contacts the relevant device directly and instructs the change of device ownership.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method for time-sharing a mobile device between multiple users over a communications network while the mobile device is located in a target carrier network, comprising:
providing a list of mobile devices from a mobile device pool and their availability;
enabling a user to check out a particular available mobile device from the mobile device pool; and
displaying an image of the checked out mobile device.

2. The method of claim 1, further comprising enabling the user to make a reservation for a particular mobile device in a particular time-slot.

3. A computer-readable medium comprising program code for time-sharing a mobile device between multiple users over a communications network while the mobile device is located in a target carrier network, the program code for causing performance of a method comprising:
providing a list of mobile devices from a mobile device pool and their availability;
enabling a user to check out a particular available mobile device from the mobile device pool; and
displaying an image of the checked out mobile device.

4. The computer-readable medium of claim 3, the method further comprising enabling the user to make a reservation for a particular mobile device in a particular time-slot.

5. A system for time-sharing a mobile device between multiple users over a communications network while the mobile device is located in a target carrier network, comprising:
a device conductor configured for
providing a list of mobile devices from a mobile device pool and their availability,
enabling a user to check out a particular available mobile device from the mobile device pool, and
displaying an image of the checked out mobile device.

6. The system of claim 5, the device conductor further configured for enabling the user to make a reservation for a particular mobile device in a particular time-slot.

7. A method for time-sharing a mobile device between multiple users over a communications network while the mobile device is located in a target carrier network, comprising:
receiving network messages from mobile devices;
maintaining a list of mobile devices from a mobile device pool and their locations and status; and
transmitting the location and status of the mobile devices to a device conductor in response to a request from the device conductor to access a mobile device.

8. The method of claim 7, further comprising:
maintaining a list of device conductor instances and their mobile devices of interest; and
transmitting the status of the mobile devices of interest to the device conductors when the status of the mobile device of interest has changed.

9. A computer-readable medium comprising program code for time-sharing a mobile device between multiple users over a communications network while the mobile device is located in a target carrier network, the program code for causing performance of a method comprising:
receiving network messages from mobile devices;
maintaining a list of mobile devices from a mobile device pool and their locations and status; and
transmitting the location and status of the mobile devices to a device conductor in response to a request from the device conductor to access a mobile device.

10. The computer-readable medium of claim 7, the method further comprising:
maintaining a list of device conductor instances and their mobile devices of interest; and
transmitting the status of the mobile devices of interest to the device conductors when the status of the mobile device of interest has changed.

11. A system for time-sharing a mobile device between multiple users over a communications network while the mobile device is located in a target carrier network, comprising:
an access server configured for
receiving network messages from mobile devices,
maintaining a list of mobile devices from a mobile device pool and their locations and status, and
transmitting the location and status of the mobile devices to a device conductor in response to a request from the device conductor to access a mobile device.

12. The system of claim 11, the access server further configured for:
maintaining a list of device conductor instances and their mobile devices of interest; and
transmitting the status of the mobile devices of interest to the device conductors when the status of the mobile device of interest has changed.

13. A system for time-sharing a mobile device between multiple users over a communications network while the mobile device is located in a target carrier network, comprising:
means for receiving network messages from mobile devices,
means for maintaining a list of mobile devices from a mobile device pool and their locations and status, and
means for transmitting the location and status of the mobile devices to a device conductor in response to a request from the device conductor to access a mobile device.

14. The system of claim 13, further comprising:
means for maintaining a list of device conductor instances and their mobile devices of interest; and
means for transmitting the status of the mobile devices of interest to the device conductors when the status of the mobile device of interest has changed.
